(19) United States
(12) Patent Application Publication
(10) Pub. No.: US 2005/0086810 A1
(43) Pub. Date: Apr. 28, 2005

(54) Decorative scissor holder with built in pencil sharpener

(76) Inventor: Sandra R. Danon, Los Angeles, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/692,648

(22) Filed: Oct. 23, 2003

(51) Int. Cl. B26B 11/00

(52) U.S. Cl. 30/123; 30/146; 30/459

(57) ABSTRACT

A decorative scissor holder system includes a scissor caddy for holding a pair of scissors. The blades of the scissors are insertable into an interior compartment of the caddy. A pencil sharpener is associated with the caddy. The caddy is decoratively shaped.

### BACKGROUND OF THE INVENTION

The present invention relates to a scissor holder. More particularly, the present invention relates to a decorative scissor holder.

There is a great need for a decorative scissor holder system. Scissors and pencil sharpeners are common tools used by young children during educational and recreational activities. A conventional pair of scissors are simply comprised of a pair of pivoted elongated planar members each having a looped handle and a cutting edge to shear thin sheets such as paper, metal foil, cloth, etc.

Many different types of scissors and pencil sharpeners have been employed during recreational, educational and professional activities. However, such systems are not always suitable for use by very young children. For example, U.S. Pat. No. 4,763,415 discloses a combined scissors and pencil sharpener. However, this is not suitable for use by young children who may not appreciate the dangers involved in sharpening a pencil while grasping a sharp pair of scissors, do not know how to properly hold the scissors while sharpening a pencil, dangerously grasp the scissors in an open position while attempting to sharpen a pencil, etc.

While systems such as the one described above may provide a means of incorporating a pencil sharpener into a pair of scissors, such systems can always be improved to provide better safety and reduce the chances that a very young user will be injured while using the system.

Accordingly, there is a need for a system that incorporates a pair of scissors and a pencil sharpener. There is also a need for a system that provides a safe way to transport the scissors. There is a further need for a system that allows both the scissors and the pencil sharpener to be transported at the same time. There is an additional need for a system that is hand-held. There is a need for a system that is inexpensive and economical to manufacture. The present invention satisfies these needs and provides other related advantages.

### SUMMARY OF THE INVENTION

A system for holding a pair of scissors and a pencil sharpener. This system is usable in any situation where it is desirable to use a pair of scissors and/or a pencil sharpener. These situations can occur anywhere children engage in educational or recreational activities.

A decorative scissor holder system includes a scissor caddy for holding a pair of scissors. The system further includes a pair of scissors having blades insertable into an interior compartment of the caddy. A pencil sharpener is associated with the caddy.

The compartment includes a first opening located on an upper end of the caddy. The scissors are inserted through the opening into the compartment.

The caddy has a second opening that is configured to receive a pencil therein. The second opening is aligned with the pencil sharpener.

The system includes indicia located on a front portion of the caddy. The indicia comprises a name of a person.

The caddy is decoratively shaped. The decorative shape includes the form of an insect. Handles of the scissors are positioned so as to aesthetically appear to be antenna of the insect. The insect can be a butterfly.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a bottom-facing orthogonal view of a scissor holder embodying the present invention;

FIG. 2 is top-facing orthogonal view of the scissor holder of FIG. 1;

FIG. 3 is a top plan view of the scissor holder of FIG. 1;

FIG. 4 is a bottom plan view of the scissor holder of FIG. 1 with a pair of scissors;

FIG. 5 is a bottom plan view of the scissor holder of FIG. 1 without a pair of scissors;

FIG. 6 is a top side view of the scissor holder of FIG. 5; and

FIG. 7 is a bottom side view of the scissor holder of FIG. 5.

### DETAILED DESCRIPTION OF THE PREFERRED EMBODIMENT

As shown in the accompanying for purposes of illustration, the present invention resides in a decorative scissor holder with a built-in pencil sharpener, generally referred to by the reference number 10. The decorative scissor holder system 10, as will be more fully described herein, is designed to be made from injection-molded plastic and form a compact way to transport and store a pair of scissors.

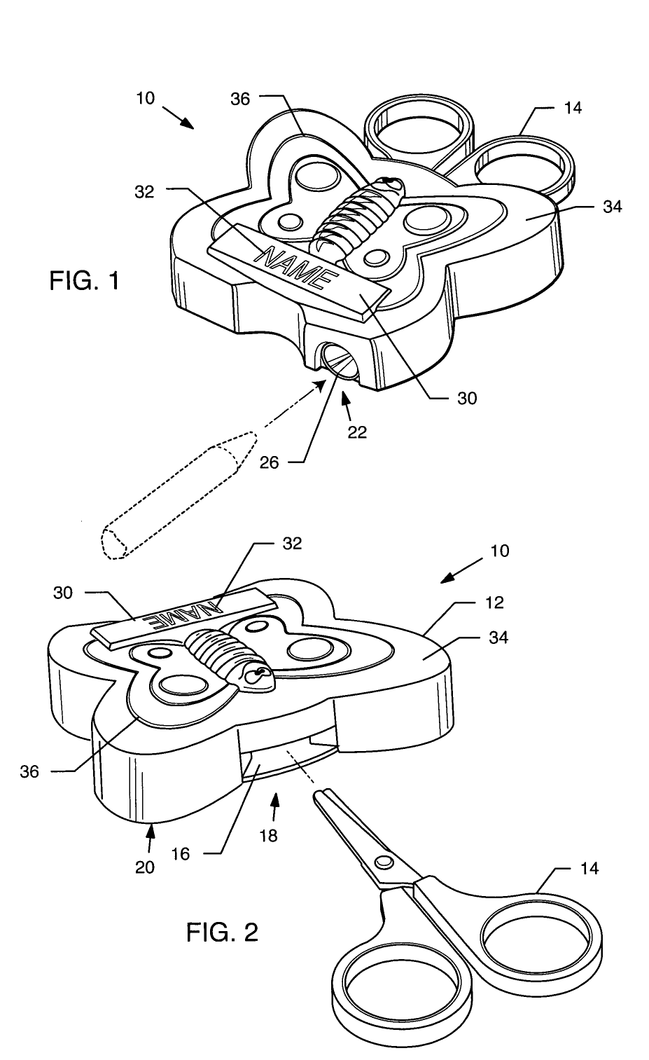

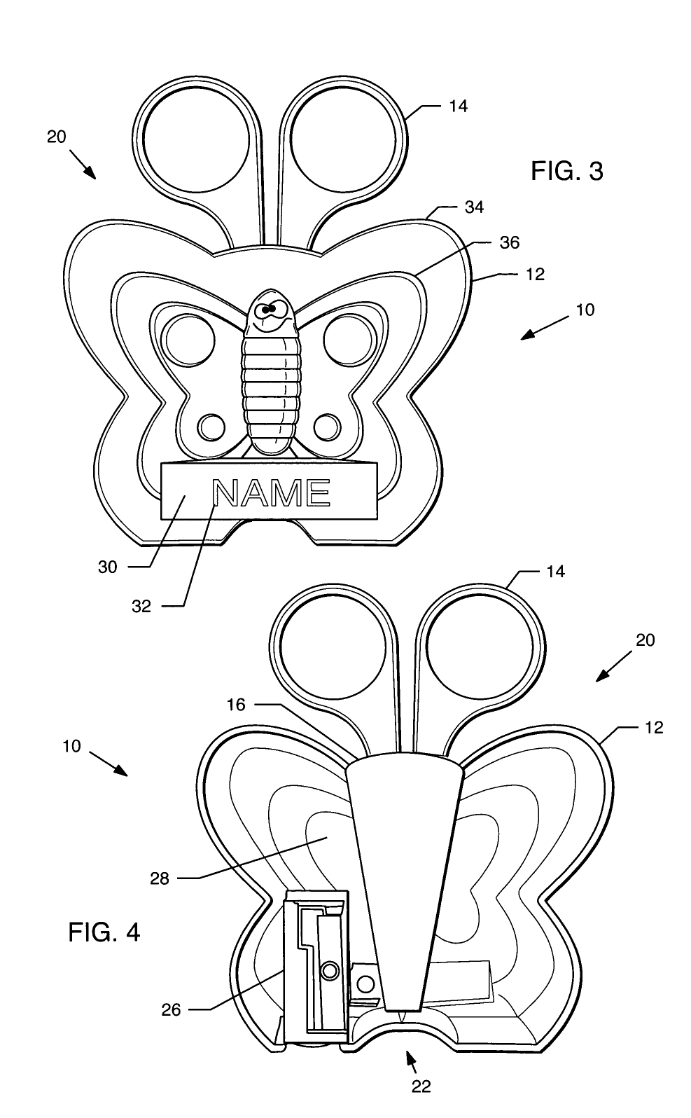

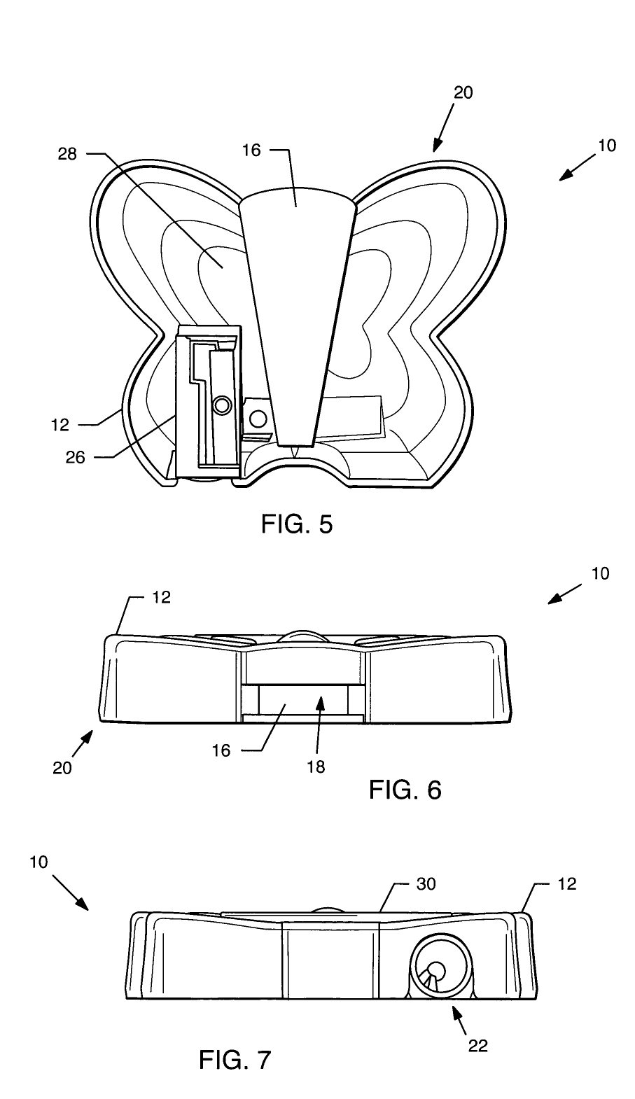

With reference now to FIGS. 1-7, the system 10 includes a scissor housing or caddy 12 for holding a pair of scissors 14. The caddy 12 includes an interior compartment 16 formed during the injection molding process. The compartment 16 may be in a variety of shapes including a tapered generally quadrilateral shape(shown), a generally rectangular, a generally triangular, or any generally polygonal shape or the like.

The compartment 16 includes a first opening 18 located on an upper side or end 20 of the caddy 12. The scissors 14 are inserted through the opening 18 into the compartment 16. The pair of scissors 14 have blades insertable into the compartment 16.

The caddy 12 has a second opening 22 that is configured to receive a pencil 24 therein. The second opening 22 is aligned with a pencil sharpener 26 is associated with the caddy 12. The pencil sharpener 26 may be manufactured separately from the caddy 12 and then permanently connected to the caddy 12 on a back portion 28 of the caddy 12. The back portion 28 is generally open and enclosed by the sides of the caddy 12. In the alternative, a crayon sharpener (not shown) may be associated with the caddy 12 and aligned with the second opening 22 of the caddy 12. In another alternative, the pencil sharpener 26 and the crayon sharpener may be interchangeable attachable to the caddy 12. In yet another alternative, both a pencil sharpener 26 and a crayon sharpener may both be permanently connected to the caddy 12 with a crayon insertable into the crayon sharpener through yet another opening in the caddy 12, with the crayon sharpener aligned with that opening.

The system 10 includes an area 30 for indicia 32 located on a front portion 34 of the caddy 12. The indicia 32 can be in the form of a name of a person, company, school, organization or the like. The indicia 32 can also be in the form of a motto, logo or symbol.

The caddy 12 is decoratively shaped and includes the form of an insect 36. Handles of the scissors 14 are positioned so as to aesthetically appear to be antenna of the insect 36. The insect can be a butterfly (shown), moth, ant, ladybug or the like. In the alternative, the caddy 12 may be in the shape of an automobile similar to the embodiment described above. The handles of the scissors 14 may be positioned so as to aesthetically appear to be the wheels or some other feature of the automobile. Likewise, a pencil sharpener 26 may associated with the automobile-shaped caddy in a manner similar to that described above.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

1. A decorative scissor holder system, comprising:
a scissor caddy;
a pair of scissors having blades insertable into an interior compartment of the caddy; and
a pencil sharpener associated with the caddy.

2. The system of claim 1, including a first opening to the compartment located on an upper end of the caddy, through which the scissors are inserted

3. The system of claim 1, including a second opening in to the caddy and configured to receive a pencil therein.

4. The system of claim 3, wherein the second opening is aligned with the pencil sharpener.

5. The system of claim 1, including indicia located on a front portion of the caddy.

6. The system of claim 5, wherein the indicia comprises a name of a person.

7. The system of claim 1, wherein the caddy is decoratively shaped.

8. The system of claim 7, wherein the decorative shape comprises the form of an insect and handles of the scissors are positioned so as to aesthetically appear to be antenna of the insect.

9. The system of claim 8, wherein the insect is a butterfly.

10. A decorative scissor holder system, comprising:
a scissor caddy;
a pair of scissors having blades insertable into an interior compartment of the caddy;
a pencil sharpener associated with the caddy;
a first opening to the compartment located on an upper end of the caddy, through which the scissors are inserted; and
including a second opening in to the caddy and configured to receive a pencil therein.

11. The system of claim 10, wherein the second opening is aligned with the pencil sharpener.

12. The system of claim 10, including indicia located on a front portion of the caddy, wherein the indicia comprises a name of a person.

13. The system of claim 10, wherein the caddy is decoratively shaped.

14. The system of claim 13, wherein the decorative shape comprises the form of an insect and handles of the scissors are positioned so as to aesthetically appear to be antenna of the insect.

15. The system of claim 14, wherein the insect is a butterfly.

16. A decorative scissor holder system, comprising:
a scissor caddy;
a pair of scissors having blades insertable into an interior compartment of the caddy; and
a pencil sharpener associated with the caddy;
including a first opening to the compartment located on an upper end of the caddy, through which the scissors are inserted; and
including a second opening in to the caddy and configured to receive a pencil therein;
wherein the second opening is aligned with the pencil sharpener, and the caddy is decoratively shaped.

17. The system of claim 16, including indicia located on a front portion of the caddy, wherein the indicia comprises a name of a person.

18. The system of claim 16, wherein the decorative shape comprises the form of an insect and handles of the scissors are positioned so as to aesthetically appear to be antenna of the insect.

19. The system of claim 18, wherein the insect is a butterfly.
